(19) United States
(12) Patent Application Publication
(10) Pub. No.: US 2018/0308107 A1
(43) Pub. Date: Oct. 25, 2018

(54) LIVING-BODY DETECTION BASED ANTI-CHEATING ONLINE RESEARCH METHOD, DEVICE AND SYSTEM

(71) Applicant: Guangdong Matview Intelligent Science & Technology Co., Ltd., Guangzhou (CN)

(72) Inventor: Libang Deng, Guangzhou (CN)

(21) Appl. No.: 15/709,453

(22) Filed: Sep. 19, 2017

(30) Foreign Application Priority Data
Apr. 24, 2017 (CN) 201710272344.1

(51) Int. Cl. G06Q 30/00; G06K 9/00; G06K 9/62; G06K 9/48; G06Q 30/02

(52) U.S. Cl. CPC G06Q 30/0185; G06K 9/00288; G06K 9/00281; G06Q 30/0203; G06K 9/6215; G06K 9/481; G06K 9/00906

(57) ABSTRACT

The present invention discloses a living-body detection based anti-cheating online research method, device and system. The method comprises the following steps: a model establishment step of establishing an action recognition model base; an information acquisition step of acquiring action recognition information about a user, the action recognition information comprising a current feature vector of a human face; and a feature comparison step of comparing the action recognition information about the user to a verification feature vector in the action recognition model base, the verification being passed if a comparison result indicates consistency. In the present invention, human facial recognition is introduced to an online questionnaire research system to conduct living-body detection; by adding a user verification link in which a facial action is completed as prompted, combined with the living-body detection technique, the validity and authenticity of questionnaire sample data is improved.

### CROSS REFERENCE TO RELATED APPLICATIONS

The present application claims the benefit of Chinese Patent Application No. 201710272344.1 filed on Apr. 24, 2017. All the above are hereby incorporated by reference.

### TECHNICAL FIELD

The present invention relates to the technical field of image recognition, especially to a living-body detection based anti-cheating online research method, device and system.

### BACKGROUND

At present, with the development of the Internet, the online research has become one of the main ways to acquire data through market researches. How to identify the authenticity and validity of users during researches is the primary problem in determining whether a questionnaire data sample acquired in online survey is valid. The existing online questionnaire research systems mainly make a validity determining at the link of user registration, for example, issuing a verification code and requiring a user to submit it for verification, asking the user questions from multiple views based on the determining of the validity of question answers, and so on. Since a computer simulating a human in identifying and submitting a verification code is technically mature now, and the situation where questionnaires are answered by machines in place of humans often occurs as well, the authenticity and validity of sample data for online questionnaire researches are greatly reduced.

### SUMMARY OF INVENTION

To overcome the deficiencies of the prior art, the first objective of the present invention is to provide a living-body detection based anti-cheating online research method, which is capable of checking the authenticity of users.

The second objective of the present invention is to provide a living-body detection based anti-cheating online research device, which is capable of checking the authenticity of users.

The third objective of the present invention is to provide a living-body detection based anti-cheating online research system, which is capable of checking the authenticity of users.

The first objective of the present invention is implemented using the following technical solution:

A living-body detection based anti-cheating online research method comprises the following steps:

a model establishment step of establishing an action recognition model base;

an information acquisition step of acquiring action recognition information about a user, the action recognition information comprising a current feature vector of a human face; and

a feature comparison step of comparing the action recognition information about the user to a verification feature vector in the action recognition model base, the verification being passed if a comparison result indicates consistency.

Further, the model establishment step particularly comprises the following sub-steps:

an action acquisition step of acquiring verification action information, wherein the verification action information comprises a verification feature vector of the human face, and the verification feature vector is the displacement change of a verification feature point; and

an action model base establishment step of establishing an action model base according to the verification action information and an operation instruction corresponding thereto.

Further, the model establishment step further comprises a facial recognition step of constructing a facial recognition model base according to the acquired facial recognition information about the user.

Further, the feature comparison step particularly comprises the following sub-step:

a similarity determining step of determining whether the similarity between the action recognition information and the verification action information in the action recognition model base is greater than a pre-set value, the verification being passed if yes.

Further, the feature comparison step further comprises a facial comparison step of comparing the acquired facial recognition information to data in the facial recognition model base, and performing the similarity determining step if a comparison result indicates consistency.

The second objective of the present invention is implemented using the following technical solution:

A living-body detection based anti-cheating online research device comprises the following modules:

a model establishment module for establishing an action recognition model base;

an information acquisition module for acquiring action recognition information about a user, the action recognition information comprising a current feature vector of a human face; and

a feature comparison module for comparing the action recognition information about the user to a verification feature vector in the action recognition model base, the verification being passed if a comparison result indicates consistency.

Further, the model establishment module particularly comprises the following sub-modules:

an action acquisition module for acquiring verification action information, wherein the verification action information comprises a verification feature vector of the human face, and the verification feature vector is the displacement change of a verification feature point; and

an action model base establishment module for establishing an action model base according to the verification action information and an operation instruction corresponding thereto.

Further, the model establishment module further comprises a facial recognition module for constructing a facial recognition model base according to the acquired facial recognition information about the user.

Further, the feature comparison module particularly comprises the following sub-module:

a similarity determining module for determining whether the similarity between the action recognition information and the verification action information in the action recognition model base is greater than a pre-set value, the verification being passed if yes.

The third objective of the present invention is implemented using the following technical solution:

A living-body detection based anti-cheating online research system comprises an executor, wherein the executor is used for executing the living-body detection based anti-cheating online research method as described in any one of the above.

Compared to the prior art, the beneficial effects of the present invention are as follows:

In the present invention, human facial recognition is introduced to an online questionnaire research system to conduct living-body detection; by adding a user verification link in which a facial action is completed as prompted, combined with the living-body detection technique, the validity and authenticity of questionnaire sample data is improved, avoiding the occurrence of large amounts of invalid questionnaires due to deceptively answering questions by utilizing a machine.

### BRIEF DESCRIPTION OF THE DRAWINGS

FIG. 1 is a flowchart of a living-body detection based anti-cheating online research method of the present invention; and

FIG. 2 is a structural diagram of a living-body detection based anti-cheating online research device of the present invention.

### DETAILED DESCRIPTION

Hereinafter, further description is made to the present invention in combination with the accompany drawings and the detailed description. It should be noted that various embodiments or various technical features described below can be arbitrarily combined to form new embodiments without conflict.

The living-body detection based anti-cheating online research system of the present invention primarily comprises: a smart device, a camera and a server.

The smart device is a computer connected with a camera or a mobile terminal with a camera, such as a mobile phone. A user accesses an online questionnaire via the smart device, and performs relevant operations, such as registration, login, questionnaire setting, and question answering.

The camera is used for acquiring the user's facial video images during using the questionnaire system.

The server is provided with a user management module, a questionnaire module and a user verification module; the server is connected with the smart device via a wireless network or an optical cable.

The user management module is used for acquiring and managing user data and allocating authority, which comprises three parts of registration, login and user authority management.

Registration: through a registration procedure, a user is guided to submit basic identity data information and set a password, and the user is prompted to make a specified action through the camera so as to acquire facial video image data of the registered user. The information mentioned above is sent to a user authority management module, and a facial recognition model and basic data information of each user are established and saved correspondingly.

Login: through a login procedure, identity information about the user is verified, the user's basic data is matched, and user verification is performed when necessary; and when the user logs in successfully, the user information is sent to the user authority management module so as to determine user authority.

User authority management: basic data information about the user, and corresponding facial recognition model information, questionnaire setting and management authority or questionnaire answering authority are saved and managed; through the data information submitted and account type information selected upon user registration, the questionnaire setting or question answering authority corresponding to the user are configured, and authority determination and allocation are performed after the user logs in; and a facial model corresponding to the user is established by means of the facial video acquired upon user registration, for verifying user consistency.

The questionnaire module comprises three parts of questionnaire setting, online questionnaire and questionnaire data analysis.

Questionnaire setting: a questionnaire management user configures questionnaire contents, a research question type, a matched user type by means of a questionnaire setting module, and issues the questionnaire after the setting is completed.

Online questionnaire: the user views the contents of questions through the online questionnaire, and performs corresponding operations to answer the questions and submits information; and the online questionnaire comprises research questions set by a questionnaire management user and randomly inserted user verification questions. The randomly inserted user verification questions can effectively improve the authenticity of questionnaire data. In the process of the user answering questions, a facial action instruction configured by a recognition and verification module is randomly extracted; video of a specified facial action completed by the user as prompted is acquired through the camera, is compared to the user's facial model to verify the user consistency, and is compared to the recognition model to verify the user authenticity.

Questionnaire data: the questionnaire data analysis module acquires the question answering information submitted by the user, performs analysis processing on the question answering information, and shows a questionnaire data result to the questionnaire management user for viewing.

The user verification module comprises verification of user consistency and verification of user authenticity.

The verification of user consistency: a key frame in the facial video images of the user during questionnaire research or login authentication is extracted, the user's facial feature is extracted and compared to the user's facial feature model which is established according to the facial video images submitted upon user registration, so as to verify the user consistency; and when a similarity is greater than 80%, it is considered to be the same user.

The principal process is:

analyzing the facial video images submitted upon user registration, extracting a key frame; constructing 72 key points of various parts of the face according to attributes such as the shape, size, position and distance of the five sense organs and profile of the face such as iris, nasal alar and angulus oris, then calculating geometric quantities thereof, forming a feature vector for describing the face through the geometric quantities, establishing a set of facial feature vectors for each registered user as the user's facial feature model and correspondingly storing same to the user authority management module, for later model comparison when verifying the user consistency; and

when user verification is performed in the process of the user logging in or answering questions, extracting a key frame of the user's facial video during verification, and comparing the feature vectors of the 72 points on the face to the facial feature model of the corresponding user, so as to determine user consistency.

The verification of user authenticity comprises a recognition model and authenticity verification. The user's facial action video images acquired by the camera are analyzed by utilizing an established recognition model; and a feature vector of the user's facial action change is extracted, and is compared to the recognition model to verify user authenticity.

Recognition model: by extracting a key frame from the facial video images and constructing facial key points, features of the key points are extracted; by learning the facial action video of a large amount of users, a training set template base is established, as a recognition model for the verification of user authenticity, according to action instruction information corresponding to variation information about the key points when the user's facial action changes.

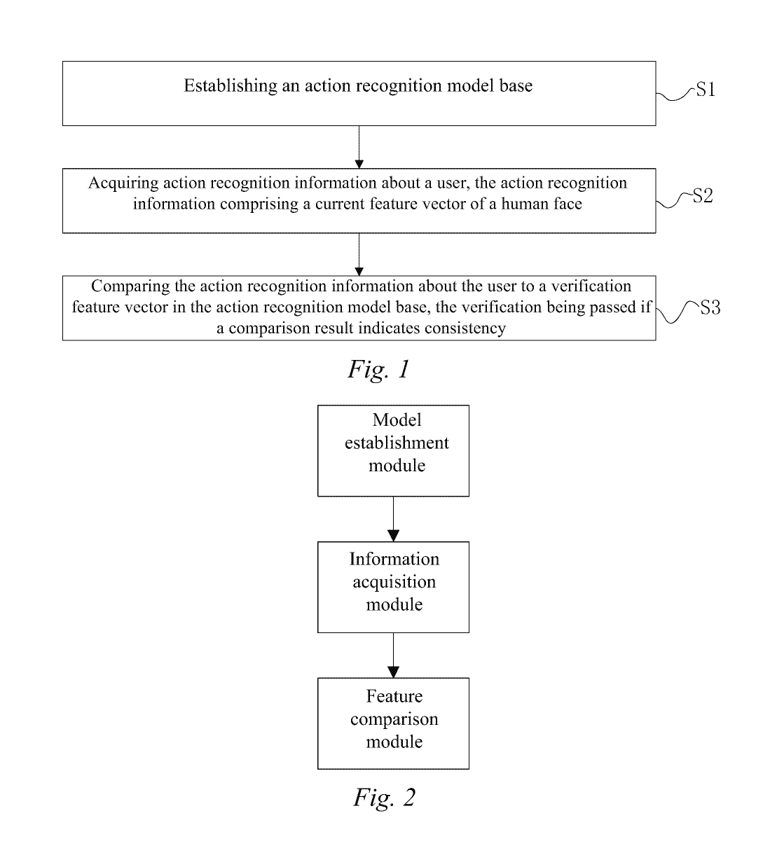

As shown in FIG. 1, the present invention provides a living-body detection based anti-cheating online research method, comprising the following steps:

S1: an action recognition model base is established. The model establishment step particularly comprises the following sub-steps:

S11: a facial recognition model base is constructed according to the acquired facial recognition information about the user. The facial structure and combination of five sense organs of a human have significant change characteristics upon different facial action changes. Through learning and continuous correction, 72 key points that can reflect facial action changes of the human and are stable when various angles of the human face are shifted under the influence of various ray-casting external environments are found according to attributes such as the shape, size, position and combination distance of the five sense organs and profile of the face such as iris, nasal alar, angulus oris and cheekbones, and a recognition model base is established based on the 72 key points. This step mainly consists in collecting primary facial information about the human, for use in later facial recognition and verification.

S12: verification action information is acquired, wherein the verification action information comprises a verification feature vector of the human face, and the verification feature vector is the displacement change of a verification feature point. The user verification actions are divided into 5 instructions, i.e., nod, turning the head to the left, turning the head to the right, blinking and opening the mouth, and a recognition model is established according to a coordinate offset vector of the 72 facial points under the various action instructions.

S13: an action model base is established according to the verification action information and an operation instruction corresponding thereto. By training through machine learning and by analyzing a large amount of facial action change video of users, statistics is made about point coordinate information change data of the 72 key points upon different facial action changes, and a coordinate offset vector of the points under different action instructions is calculated, so as to form a human face feature vector for each action instruction; and the extracted verification feature vectors of the human face are stored in correspondence to various action instruction template bases, so as to establish a recognition model for user authentication. In the training process, the recognition result needs to be compared constantly to correct the vector set for each instruction; and this step mainly consists in identifying whether a real human is answering questions through a verification action.

S2: action recognition information about a user is acquired, the action recognition information comprising a current feature vector of a human face. This step is primarily used for collecting data, and can be inserted into the login period of the user or inserted into the process of the user answering questions of the questionnaire.

S3: the action recognition information about the user is compared to a verification feature vector in the action recognition model base, and the verification is passed if a comparison result indicates consistency. The feature comparison step particularly comprises the following sub-steps:

S31: the acquired facial recognition information is compared to data in the facial recognition model base, and the similarity determining step is performed if a comparison result indicates consistency.

S32: whether the similarity between the action recognition information and the verification action information in the action recognition model base is greater than a pre-set value is determined, and the verification is passed if yes; in this way, the acquired information is verified.

The primary application procedure of the present invention is:

when accessing an online questionnaire research system, a user clicks registration, submits identity data information and account type (an ordinary question-answering user or a questionnaire management user) relevant information, and starts to establish a user account;

the user verification module randomly generates a set of living-body detection user verification instructions, and acquires through the camera facial video images of the user completing a specified facial action as prompted;

a feature vector for the user's facial action in the video images is extracted and compared to a set of feature vectors of the corresponding action in the recognition model, and the verification is passed when a similarity is greater than 80%; and

the user's facial feature vector is extracted and stored, and the user's facial feature model is established and is stored to the user management module in correspondence to the registration relevant identity information submitted by the user. The user registration is completed through the above-mentioned steps.

After the registration, the user starts a login procedure when needing to use a questionnaire research system. When an ordinary account is being logged in, the login can be completed by only verifying the password of the user account. In the case where the account has been exceptional (for example, password verification is successfully passed after inputting a wrong password for many times), a user authentication procedure is entered into.

The user is prompted to complete a relevant facial action according to an instruction through the camera, such as opening the mouth and blinking. After acquiring the user's facial video, the user verification module extracts the user's facial feature vector in the video and compares same to a facial feature model of the corresponding user stored in the system to determine user consistency, and after the user consistency is determined, makes determining about the consistency of specified actions, so as to verify user authenticity; and the user successfully logs in when every verification is passed, and can enter the questionnaire research system to perform relevant operations.

When the user enters the questionnaire research system and answers questions, the question type of specified facial action would be randomly inserted, so as to improve the authenticity of the questionnaire samples. In particular, after an ordinary question is answered, a question of facial action will be entered into. The system acquires through the camera video images of the user completing the specified facial action as prompted, extracts the user's facial feature vector user in the video and compares same to the user's facial feature model to verify user consistency, and compares same to a set of feature vectors of the corresponding action in the recognition model so as to verify user authenticity; and the question is answered when the verifications are passed, and the next question answering link is entered into.

The questionnaire data analysis module acquires the complete question answering information submitted by the user, performs analysis processing on the question answering information, and shows a questionnaire data result to the questionnaire management user for viewing.

The method described above is the most preferred solution of this embodiment. Verification can also be made in other ways, for example, when determining user consistency, whether the user is submitting the questionnaire or performing other relevant operations by his/her own is verified; when acquiring sample data about a specified crowd, this step can improve the accuracy in matching the basic user information about the questionnaire samples, and can avoid the occurrence of the case where other users not satisfying the properties answer questions in place of the registered user. In this step, basic user information can be verified in other question asking methods without making a determining. In the link of user authenticity verification, true-false items can also be set randomly, and the user is allowed to answer by nodding with Yes and shaking the head with No; at the same time, the correctness of the answer and the consistency between the feature vector of the user's facial action video images and the recognition model are determined, so as to complete the verification of the real user.

As shown in FIG. 2, the present invention provides a living-body detection based anti-cheating online research device, comprising the following modules:

a model establishment module for establishing an action recognition model base; wherein the model establishment module particularly comprises the following sub-modules:

a facial recognition module for constructing a facial recognition model base according to the acquired facial recognition information about the user.

an action acquisition module for acquiring verification action information, wherein the verification action information comprises a verification feature vector of the human face, and the verification feature vector is the displacement change of a verification feature point; and

an action model base establishment module for establishing an action model base according to the verification action information and an operation instruction corresponding thereto.

an information acquisition module for acquiring action recognition information about a user, the action recognition information comprising a current feature vector of a human face; and

a feature comparison module for comparing the action recognition information about the user to a verification feature vector in the action recognition model base, the verification being passed if a comparison result indicates consistency. The feature comparison module particularly comprises the following sub-modules:

a facial comparison module for comparing the acquired facial recognition information to data in the facial recognition model base, and performing the similarity determining module if a comparison result indicates consistency; and

a similarity determining module for determining whether the similarity between the action recognition information and the verification action information in the action recognition model base is greater than a pre-set value, the verification being passed if yes.

Above-mentioned embodiments only are preferred embodiments of the present invention, they cannot limit the scope of protection of the present invention, furthermore, all the non-substantial modifications and substitutions made by a person skilled in the art based on the present invention belong the scope of protection of the present invention.

What is claimed is:

1. A living-body detection based anti-cheating online research method, comprising the following steps:
a model establishment step of establishing an action recognition model base;
an information acquisition step of acquiring action recognition information about a user, the action recognition information comprising a current feature vector of a human face; and
a feature comparison step of comparing the action recognition information about the user to a verification feature vector in the action recognition model base, the verification being passed if a comparison result indicates consistency.

2. The living-body detection based anti-cheating online research method of claim 1, wherein the model establishment step particularly comprises the following sub-steps:
an action acquisition step of acquiring verification action information, wherein the verification action information comprises a verification feature vector of the human face, and the verification feature vector is the displacement change of a verification feature point; and
an action model base establishment step of establishing an action model base according to the verification action information and an operation instruction corresponding thereto.

3. The living-body detection based anti-cheating online research method of claim 2, wherein the model establishment step further comprises a facial recognition step of constructing a facial recognition model base according to the acquired facial recognition information about the user.

4. The living-body detection based anti-cheating online research method of claim 3, wherein the feature comparison step particularly comprises the following sub-step:
a similarity determining step of determining whether the similarity between the action recognition information and the verification action information in the action recognition model base is greater than a pre-set value, the verification being passed if yes.

5. The living-body detection based anti-cheating online research method of claim 4, wherein the feature comparison step further comprises a facial comparison step of comparing the acquired facial recognition information to data in the facial recognition model base, and performing the similarity determining step if a comparison result indicates consistency.

6. A living-body detection based anti-cheating online research device, comprising the following modules:
a model establishment module for establishing an action recognition model base;
an information acquisition module for acquiring action recognition information about a user, the action recognition information comprising a current feature vector of a human face; and
a feature comparison module for comparing the action recognition information about the user to a verification feature vector in the action recognition model base, the verification being passed if a comparison result indicates consistency.

7. The living-body detection based anti-cheating online research device of claim 6, wherein the model establishment module particularly comprises the following sub-modules:
an action acquisition module for acquiring verification action information, wherein the verification action information comprises a verification feature vector of the human face, and the verification feature vector is the displacement change of a verification feature point; and
an action model base establishment module for establishing an action model base according to the verification action information and an operation instruction corresponding thereto.

8. The living-body detection based anti-cheating online research device of claim 7, wherein the model establishment module further comprises a facial recognition module for constructing a facial recognition model base according to the acquired facial recognition information about the user.

9. The living-body detection based anti-cheating online research device of claim 8, wherein the feature comparison module particularly comprises the following sub-module:
a similarity determining module for determining whether the similarity between the action recognition information and the verification action information in the action recognition model base is greater than a pre-set value, the verification being passed if yes.

10. A living-body detection based anti-cheating online research system, comprising an executor, wherein the executor is used for executing the living-body detection based anti-cheating online research method of claim 1.
